(19) United States
(12) Patent Application Publication
(10) Pub. No.: US 2025/0308500 A1
(43) Pub. Date: Oct. 2, 2025

(54) ACTIVE VIBRATION NOISE REDUCTION DEVICE

(71) Applicant: HONDA MOTOR CO., LTD., Tokyo (JP)

(72) Inventors: Xun WANG, Wako-shi (JP); Takuma MAESAKA, Wako-shi (JP); Toshio INOUE, Wako-shi (JP)

(21) Appl. No.: 19/062,756

(22) Filed: Feb. 25, 2025

(30) Foreign Application Priority Data
Mar. 27, 2024 (JP) 2024-052500

(51) Int. Cl. G10K 11/178

(52) U.S. Cl. CPC G10K 11/17817; G10K 11/17815; G10K 11/17881; G10K 2210/1282; G10K 2210/30232; G10K 2210/3054

(57) ABSTRACT

An active vibration noise reduction device includes: a speaker that outputs a cancellation sound for canceling noise; a microphone that generates an error signal from the noise and the cancellation sound; a control filter configured to generate a control signal for controlling the cancellation sound from a reference signal; and a secondary path filter presenting an estimation value of a transfer function from the speaker to the microphone, wherein the control filter is configured to be adaptively updated by an update amount obtained by multiplying the error signal, a step size parameter calculated based on the error signal, and a result of convolution between the reference signal and the secondary path filter.

### CROSS REFERENCE TO RELATED APPLICATIONS

This application claims foreign priority to Japanese Patent Application No. 2024-052500, filed Mar. 27, 2024, the disclosure of which is incorporated herein by reference in its entirety.

### TECHNICAL FIELD

The present invention relates to an active vibration noise reduction device.

### BACKGROUND ART

Conventionally, active noise reduction devices and the like have been studied that reduce noise by generating a cancellation sound having a phase opposite to that of noise (for example, road noise) generated in a vehicle compartment and causing the generated cancellation sound to interfere with the noise.

For example, Japanese Patent No. 2751685 describes, in paragraph 0008, an active noise control device that controls a control sound output from a control sound source by: expressing a target value of an indoor noise level in a vehicle or the like with a function of frequency characteristics of a noise source such as an engine, e.g., with a function of the number of revolutions; obtaining a sound pressure error between the target value and a residual noise level at the current number of revolutions; determining a convergence coefficient based on the sound pressure error; and updating a filter coefficient of adaptive digital filter processing by a steepest descent method using the convergence coefficient.

### SUMMARY OF THE INVENTION

### Problems to be Solved by the Invention

The active noise control device proposed in Japanese Patent No. 2751685 is intended to form a comfortable space that does not give an unpleasant sound to an occupant regardless of a change in the number of engine revolutions. Specifically, the target value of the noise level in the vehicle compartment is calculated based on the current number of engine revolutions by consulting the target value storage table of FIG. 6 of Japanese Patent No. 2751685. The active noise control device calculates a residual noise level and calculates a sound pressure error between the target value and the residual noise level. Then, the active noise control device determines the convergence coefficient by consulting the convergence coefficient storage table (map) of FIG. 7 of Japanese Patent No. 2751685.

Here, as illustrated in FIG. 7 of Japanese Patent No. 2751685, when the sound pressure error is equal to or larger than a predetermined value, the convergence coefficient is constant. Due to this, when the sound pressure error is large, such as at the initial stage of control or when the position of the microphone is changed, there is room for improvement in order to increase the convergence. In particular, in order to flatten the residual noise characteristics and improve the stability, it is necessary to adjust the convergence coefficient storage table of FIG. 7. However, the setting of the convergence coefficient storage table is complicated.

The present invention has been made in view of the above circumstances, and an object of the present invention is to provide an active noise reduction device capable of easily setting filter coefficients to be adaptively applied to a control filter that generates a signal for canceling noise by updating the filter coefficients with optimum values.

### Solution to the Problems

The active vibration noise reduction device includes: a speaker for outputting a cancellation sound for canceling a noise; a microphone for generating an error signal from the noise and the cancellation sound; a control filter configured to generate a control signal for controlling the cancellation sound from a reference signal; and a secondary path filter configured to present an estimation value of a transfer function from the speaker to the microphone, wherein the control filter is further configured to be adaptively updated with an update amount obtained by multiplying the error signal, a step size parameter calculated based on the error signal, and a result of convolution between the reference signal and the secondary path filter.

### Effects of the Invention

According to the present invention, it is possible to update adaptive filter coefficients for a control filter that generates a signal for canceling noise, with optimum values and easily set the filter coefficients. In particular, in the present invention, the active noise reduction device automatically adjusts the update amount for adaptively updating the control filter according to the magnitude of the error signal, based on predetermined update formula. With this, for example, when the error signal is large as in the initial stage of control, the active noise reduction device improves the convergence speed because the update amount is large. On the other hand, for example, when the error signal is small as in the case after the control convergence, the active noise reduction device improves the accuracy of the adaptive update because the update amount is also small.

### BRIEF DESCRIPTION OF THE DRAWINGS

FIG. 1 is a block diagram illustrating a schematic configuration of an active vibration noise reduction device according to an embodiment.

FIG. 2 is an explanatory diagram illustrating the concept of adaptively updating a control signal generator of a noise controller;

FIG. 3 is an explanatory diagram illustrating an LMS algorithm for calculating filter coefficients that minimize an evaluation function.

### DETAILED DESCRIPTION OF EMBODIMENT

Hereinafter, modes for carrying out the present invention (hereinafter referred to embodiments) will be described in detail. The embodiments described below are merely examples for implementing the present invention, and should be appropriately modified or changed depending on the configuration of the device to which the present invention is applied and on various conditions. In the drawings, the same components are denoted by the same reference signs, and the description thereof will be appropriately omitted.

In the present specification, [symbol] (hat) written together with a reference sign presents an identified value or an estimation value.

### Present Embodiment

### Schematic Configuration of Active Vibration Noise Reduction Device

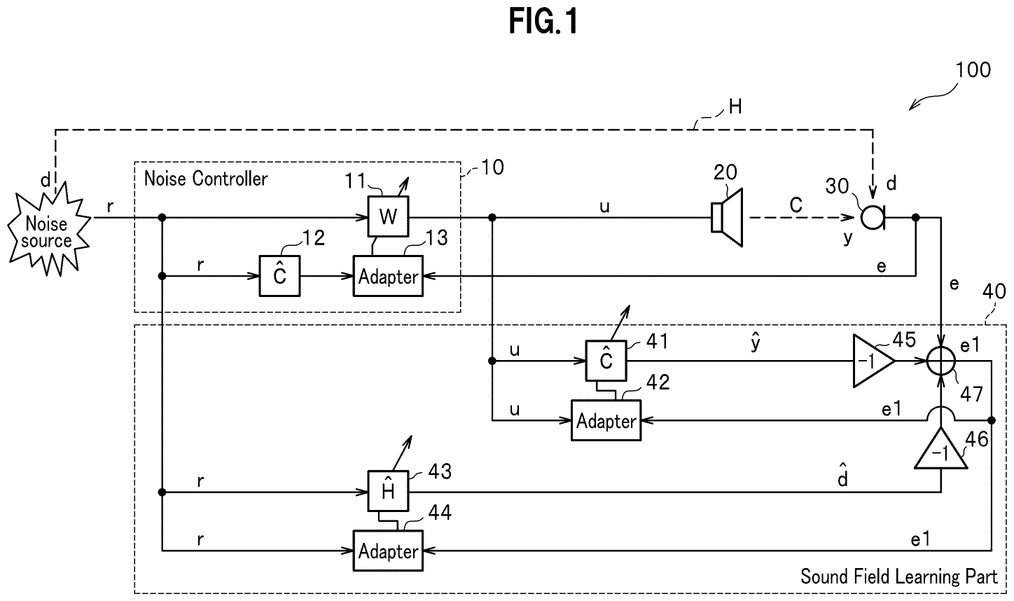

FIG. 1 is a block diagram illustrating a schematic configuration of an active vibration noise reduction device according to the present embodiment. An active vibration noise reduction device 100 illustrated in FIG. 1 constitutes an Active Noise Control (ANC) device for reducing noise generated in a vehicle compartment.

Various noises such as a tire noise, a wind noise, and an engine noise are generated in the vehicle compartment during traveling. An ANC device is provided in the vehicle to cancel a noise d generated due to transmission of vibration of the power unit (engine, motor, or the like) or due to the inflow of an exhaust sound or the like, thereby realizing a vehicle with high quietness and creating a comfortable and high-quality space in the vehicle compartment.

Specifically, the active vibration noise reduction device 100 generates a cancellation sound y with a phase opposite to that of the noise d due to the noise source to cause the generated cancellation sound y to interfere with the noise d, thereby reducing the noise d. The noise d corresponds to, for example, road noise caused by the wheel vibration due to forces from a road surface. Note that the road noise is an example of the noise d. The noise d may be a noise other than the road noise, for example, a driving system noise caused by vibration of a driving source such as an internal combustion engine or an electric motor.

As illustrated in FIG. 1, the active vibration noise reduction device 100 according to the present embodiment includes a noise controller 10, a speaker 20, a microphone 30, and a sound field learning part 40. The transfer function H illustrated in FIG. 1 indicates a noise transmission path and indicates a transfer function of a primary path from the noise source to the microphone 30. The transfer function C illustrated in FIG. 1 indicates a transfer function of a secondary path from the speaker 20 to the microphone 30.

The speaker 20 outputs the cancellation sound y for canceling the noise d. The speaker 20 is provided, for example, in front of the driver's seat or in a door on a lateral side of an occupant seat.

The microphone 30 generates an error signal e from the noise d and the cancellation sound y. The microphone 30 is provided, for example, in a headrest of a driver's seat. The microphone 30 generates an error signal e based on the cancellation sound y output from the speaker 20 and the noise d at the position of the microphone 30.

The noise controller 10 and the sound field learning part 40 are composed of, for example, a computer including an arithmetic processing device (a processor such as a central processing unit (CPU) or a micro processing unit (MPU)) and a storage device (a memory such as a read only memory (ROM) or a random access memory (RAM)). That is, the active vibration noise reduction device 100, except for the speaker 20 and the microphone 30, may be constructed as a single hardware unit or a unit including a plurality of hardware units, for example.

A reference signal r corresponding to the noise d is input to the noise controller 10. The reference signal r is input to the noise controller 10 from, for example, a reference microphone (not illustrated) that generates the reference signal r from the noise d. The noise controller 10 includes a control filter part 11, a secondary path filter part 12, and a control updater 13.

The control filter part 11 generates a control signal u for controlling the cancellation sound y from the reference signal r. The control signal u cancels the noise d by controlling the cancellation sound y. The control filter part 11 is constituted by a control filter W. The control filter W is a finite impulse response (FIR) filter, for example.

An FIR filter is a kind of digital filter and is a filter with an impulse response whose continuation duration is finite. In other words, an FIR filter is a filter such that the output signal (impulse response) output when an impulse signal is input converges within a finite time. The control filter part 11 may constitute the control filter W by another kind of filter (e.g., a single-frequency adaptive notch filter).

The control filter part 11 generates the control signal u for controlling the speaker 20 by performing a filtering process on the reference signal r using the control filter W. The control filter part 11 inputs the generated control signal u to the speaker 20. The speaker 20 generates the cancellation sound y corresponding to the control signal u generated by the control filter part 11. The control filter part 11 also inputs the generated control signal u to the sound field learning part 40.

The secondary path filter part 12 is constituted by a secondary path filter Ĉ that presents an estimation value of the transfer function C from the speaker 20 to the microphone 30. The secondary path filter Ĉ is a filter that presents an estimation value of the transfer function C of the secondary path. The secondary path filter Ĉ is constituted by an FIR filter, for example. The secondary path filter Ĉ may be constituted by another kind of filter (for example, a single-frequency adaptive notch filter).

The secondary path filter part 12 corrects the reference signal r by filtering the reference signal r using the secondary path filter Ĉ. The secondary path filter part 12 inputs the corrected reference signal r to the control updater 13.

The control updater 13 adaptively updates the control filter W of the control filter part 11 using an adaptive algorithm such as Least Mean Square algorithm (LMS algorithm). Specifically, the control updater 13 adaptively updates the control filter W so that the error signal e output from the microphone 30 is minimized. In the present embodiment, an adaptive update algorithm (described later) is employed in which the control filter W is adaptively updated by adaptively updating the filter coefficients.

The sound field learning part 40 includes a cancellation sound estimation signal generator 41, a secondary path updater 42, a noise estimation signal generator 43, a primary path updater 44, a cancellation sound estimation signal inverter 45, a noise estimation signal inverter 46, and a virtual error signal generator 47.

The cancellation sound estimation signal generator 41 is constituted by a secondary path filter C. The secondary path filter Ĉ of the cancellation sound estimation signal generator 41 is a filter that has the identical characteristics as the secondary path filter Ĉ of the secondary path filter part 12 to present an estimation value of the transfer function C of the secondary path. When the secondary path filter Ĉ of the cancellation sound estimation signal generator 41 is adaptively updated by the below-described secondary path updater 42, the secondary path filter Ĉ of the secondary path filter part 12 is updated in synchronization to be the same as the secondary path filter Ĉ of the cancellation sound estimation signal generator 41 by the secondary path updater 42. The secondary path filter Ĉ of the cancellation sound estimation signal generator 41 is constituted by, for example, an FIR filter to be consistent with the secondary path filter Ĉ of the secondary path filter part 12. The secondary path filter Ĉ of the cancellation sound estimation signal generator 41 may be constituted by another kind of filter (for example, a single-frequency adaptive notch filter) to be consistent with the secondary path filter Ĉ of the secondary path filter part 12.

The cancellation sound estimation signal generator 41 generates, by filtering the control signal u input from the control filter part 11 of the noise controller 10 by the secondary path filter Ĉ, a cancellation sound estimation signal ŷ that presents an estimation value of the cancellation sound y. The cancellation sound estimation signal generator 41 inputs the generated cancellation sound estimation signal ŷ to the cancellation sound estimation signal inverter 45.

The secondary path updater 42 adaptively updates the secondary path filter Ĉ of the cancellation sound estimation signal generator 41 by using an adaptive algorithm such as LMS algorithm and, at the same time, updates the secondary path filter Ĉ of the secondary path filter part 12 to be the same as the secondary path filter Ĉ of the cancellation sound estimation signal generator 41. Specifically, the secondary path updater 42 adaptively updates the secondary path filters Ĉ so that the virtual error signal el input from the virtual error signal generator 47 is minimized. In the present embodiment, the secondary path updater 42 also employs an adaptive update algorithm (described later).

The noise estimation signal generator 43 is constituted by a primary path filter Ĥ. The primary path filter Ĥ is a filter that presents an estimation value of the transfer function H of the primary path. The primary path filter Ĥ is constituted by an FIR filter, for example. The primary path filter Ĥ of the noise estimation signal generator 43 may be constituted by another kind of filter (for example, a single-frequency adaptive notch filter). Note that the primary path filter Ĥ is also referred to as a sound field characteristic filter.

The noise estimation signal generator 43 generates, by filtering the reference signal r using the primary path filter Ĥ, a noise estimation signal \hat{d} that presents an estimation value of the noise d. The noise estimation signal generator 43 inputs the generated noise estimation signal \hat{d} to the noise estimation signal inverter 46.

The primary path updater 44 adaptively updates the primary path filter Ĥ of the noise estimation signal generator 43 using an adaptive algorithm such as LMS algorithm. Specifically, the primary path updater 44 adaptively updates the primary path filter Ĥ so that the virtual error signal el input from the virtual error signal generator 47 is minimized. In the present embodiment, the primary path updater 44 also employs an adaptive update algorithm (described later).

The cancellation sound estimation signal inverter 45 inverts the polarity of the cancellation sound estimation signal ŷ input from the cancellation sound estimation signal generator 41. The cancellation sound estimation signal inverter 45 inputs the cancellation sound estimation signal ŷ whose polarity has been inverted to the virtual error signal generator 47.

The noise estimation signal inverter 46 inverts the polarity of the noise estimation signal \hat{d} input from the noise estimation signal generator 43. The noise estimation signal inverter 46 inputs the noise estimation signal \hat{d} whose polarity has been inverted to the virtual error signal generator 47.

The virtual error signal generator 47 generates a virtual error signal el by adding the error signal e input from the microphone 30, the cancellation sound estimation signal ŷ with inverted polarity input from the cancellation sound estimation signal inverter 45, and the noise estimation signal \hat{d} with inverted polarity input from the noise estimation signal inverter 46. The virtual error signal generator 47 inputs the generated virtual error signal el to the secondary path updater 42 and the primary path updater 44.

### Update Processing of Active Vibration Noise Reduction Device

Next, a description will be given of update processing of the active vibration noise reduction device 100 according to the present embodiment. The update processing of the active vibration noise reduction device 100 will be described with reference to FIGS. 1 to 3.

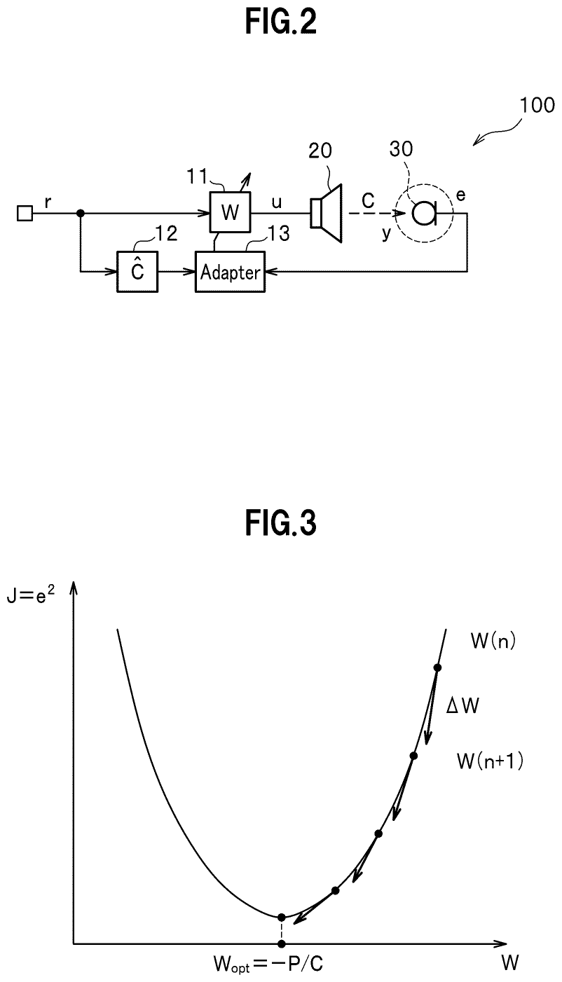

FIG. 2 is an explanatory diagram illustrating the concept of adaptively updating the control signal generator of the noise controller. The active vibration noise reduction device 100 illustrated in FIG. 2 shows that the control filter W of the control filter part 11 is adaptively updated by the control updater 13.

The control filter part 11 generates a control signal u by the adaptively updated control filter W and outputs the generated control signal u to the speaker 20. In response to this, the speaker 20 outputs the cancellation sound y. In the present embodiment, the active vibration noise reduction device 100 may constantly continue to update the control filter W and stop the update when the secondary path filter Ĉ of the secondary path filter part 12 converges, for example.

FIG. 3 is an explanatory diagram illustrating an LMS algorithm for calculating filter coefficients that minimize an evaluation function.

In FIG. 3, when calculating filter coefficients that minimize an evaluation function J (e.g., e²), the filter coefficients are set using an update amount ΔW by using an LMS algorithm for adjusting a step size parameter μW(t). In general LMS algorithms, μ is a fixed value. For example, in the algorithm illustrated in FIG. 3, the minimum value is searched for along the negative direction of the gradient of the evaluation function J. When the evaluation function J is minimized, the update amount ΔW is 0. In the algorithm illustrated in FIG. 3, when the evaluation function J reaches the minimum value, the room sound pressure (error signal e) after the noise d and the control sound interfere with each other is minimized.

Here, the direction of adaptive update of the control filter W is the direction of the angle (<ΔW) indicated by the arrow of the update amount ΔW. The update amount ΔW is the length (|ΔW|) of the arrow on the W axis illustrated in FIG. 3. Therefore, the direction of the adaptive update of the control filter W depends on the phase of the secondary path filter Ĉ.

Here, the active vibration noise reduction device 100 according to the present

embodiment is characterized in that the modification of the secondary path filter Ĉ is learned and the direction of adaptive update is automatically adjusted during control. That is, in the present embodiment, the active vibration noise reduction device 100 monitors changes in the sound field by constantly acquiring the error signal e from the microphone 30.

In other words, the adaptive update algorithm proposed in the present embodiment is designed to automatically adjust the step size parameter μW(t) according to the level of the input signal input to the control filter W and the correlation between the input signal and the error signal e.

Here, the magnitude of the update amount ΔW depends on the amplitudes of the error signal e, the reference signal r, and the secondary path filter Ĉ, and the step size parameter μW(t) is automatically adjusted taking into account the level of the error signal e.

Specifically, in the present embodiment, the control filter W is adaptively updated based on the update amount ΔW obtained by multiplying the error signal e, the step size parameter μW(t) calculated based on the error signal e, and the convolution between the reference signal r and the secondary path filter Ĉ.

In this way, the control updater 13 adaptively updates the control filter W by means of an adaptive update algorithm for adjusting the step size parameter μW(t) based on the level of the input signal inputted to the control filter W to be adapted and the correlation between the input signal and the error signal e.

First, the step size parameter μW(t) for updating the control filter W is calculated by the following Formulas (1) and (2).

$${μ}_{W} ( t ) = {μ}_{0} \frac{\vert {ρ}_{W} ( t ) \vert + β}{‖ r ( t ) * \hat{C} ( t ) ‖ + σ} \qquad ( 1 )$$

$${ρ}_{W} ( t ) = {λρ}_{W} ( t ) + ( 1 - λ ) ( r ( t ) * e ( t ) ) \qquad ( 2 )$$

where
μ0: Preset fixed value of step size parameter
σ, β: Small positive number
*: Convolution operation
   |⋅|: Norm of signal vector
λ: Oblivion coefficient (0<λ<1)

Here, ρw(t) in Formula (2) reflects the current value r(t)*e(t) to a greater extent as λ is smaller, giving more weight to the current value; and the larger λ is, the smaller the reflection of the current value r(t)*e(t), and the more the average value up to now is emphasized.

Using the step size parameter μW(t) calculated according to Formulas (1) and (2), the control updater 13 adaptively updates the control filter W according to the following update formula (3).

$$W ( t + 1 ) = W ( t ) - {μ}_{W} ( t ) e ( t ) ( r ( t ) * \hat{C} ( t ) ) \qquad ( 3 )$$

In this way, the control updater 13 adaptively updates the control filter W of the control filter part 11, and the control filter W continues to be updated.

For example, when an occupant seat is reclined, the step size parameter μW(t) of Formula (1) changes following the change in the transfer function C of the secondary path and the secondary path filter Ĉ. Then, the active vibration noise reduction device 100 calculates the update amount ΔW based on Formula (3) by multiplying the error signal e, the step size parameter μW(t) calculated based on the error signal e, and the convolution between the reference signal r and the secondary path filter Ĉ. With this, the active vibration noise reduction device 100 adaptively updates the control filter W of the control filter part 11 by the update amount ΔW.

More in detail, in Formula (1), the step size parameter μW(t) is adjusted according to the level of the input signal input to the control filter W and the correlation between the input signal and the error signal e. The step size parameter μW(t) is inversely proportional to the level of the input signal due to the presence of the norm of the signal vector in the denominator and is proportional to the correlation between the input signal and the error signal e.

Thus when the input signal is small, the step size parameter μW(t) becomes large according to Formula (1), thereby to maintain the convergence speed. On the other hand, when the input signal is large, the step size parameter μW(t) becomes small and thus divergence due to the update amount ΔW being too large can be prevented, thereby the control stability is guaranteed.

Furthermore, when the reduction amount of the noise d is small immediately after the start of the control or after the change of the secondary path filter Ĉ, the correlation between the input signal and the error signal e is large and thus the step size parameter μW(t) is also large, so that the convergence speed is increased.

On the other hand, when the control progresses and the noise d is reduced, the correlation between the input signal and the error signal e becomes small and thus the step size parameter μW(t) also becomes small, which makes it possible to adjust the filter coefficient of the control filter W with high accuracy.

Furthermore, when a disturbance is mixed in the error signal e, as the correlation becomes small and the step size parameter μW(t) also becomes small, the control stability is high. For example, this corresponds to a case where a truck is traveling next to the vehicle and the level of the vehicle body vibration signal, which is the input signal, does not change even when the microphone 30 picks up the traveling sound of the truck.

In addition, in Formula (2), the control updater 13 obtains the step size parameter μW(t) by a convolution between the error signal e corresponding to the correlation and the reference signal r.

As described above, the active vibration noise reduction device 100 according to the present embodiment includes the speaker 20, the microphone 30, the control filter W, and the secondary path filter Ĉ.

The speaker 20 outputs a cancellation sound y for canceling the noise d. The microphone 30 generates an error signal e from the noise d and the cancellation sound y. The control filter W generates a control signal u for controlling the cancellation sound y from the reference signal r. Based on Formula (3), the control filter W is adaptively updated with an update amount ΔW obtained by multiplying the error signal e, a step size parameter μW(t) calculated based on the error signal e, and a convolution between the reference signal r and the secondary path filter Ĉ.

With this configuration, the active vibration noise reduction device 100 automatically calculates the step size parameter μW(t) according to the magnitude of the error signal e and thus is capable of updating the adaptive filter coefficients with an optimal value and easily setting the filter coefficients in the control filter W. That is, for example, when the error signal e is large as in the initial stage of control, the active vibration noise reduction device 100 improves the convergence speed because the update amount is large. On the other hand, for example, when the error signal e is small as in the case after the control has converged, the update amount is also small and thus the active vibration noise reduction device 100 improves the accuracy of the adaptive update.

In this way, the active vibration noise reduction device 100 improves the convergence speed and ensure the control stability and the control performance. In particular, even when the error signal e includes a disturbance, the active vibration noise reduction device 100 improves (ensures) stability. Further, as the convergence coefficient storage table as in Japanese Patent No. 2751685 is not used, it is easy to set the filter coefficients in the control filter W of the control filter part 11.

The step size parameter μW(t) may be obtained using a convolution between the error signal e and the reference signal r as shown in Formula (2).

With this configuration, the step size parameter μW(t) represents the magnitude of the correlation between the error signal e and the reference signal r by performing a convolution operation using Formula (2). Here, a large correlation means that the noise d have not been reduced and indicates that the noise d is included in the error signal e. In view of this, the active vibration noise reduction device 100 increases (speeds up) the convergence by calculating the step size parameter μW(t) of Formula (1) including Formula (2) based on the correlation.

Furthermore, when the error signal e generated by the microphone 30 contains a disturbance, the correlation with the reference signal r becomes small and thus the step size parameter μW(t) also becomes small, which improves the control stability.

Furthermore, the control filter W performs a convolution operation corresponding to the correlation between the reference signal r and the error signal e according to Formula (2). In Formula (2), the secondary path filter Ĉ is not used for the correlation operation by the convolution between the reference signal r and the error signal e. Therefore, the calculation can be performed for each combination of the reference signal r and the error signal e and thus the same calculation is not necessarily repeated for each control channel, which makes it possible to reduce an increase in the amount of calculation due to the correlation calculation.

The step size parameter μW(t) may be obtained based on the square of the error signal e. That is, the step size parameter μW(t) may be obtained by using the square of the error signal e instead of the convolution between the error signal e and the reference signal r.

In this case, the step size parameter μW(t) is calculated using the following Formula (4) instead of Formula (2).

$${ρ}_{W} ( t ) = {λρ}_{W} ( t ) + ( 1 - λ ) {e ( t )}^{2} \qquad ( 4 )$$

According to such a configuration, the step size parameter μW(t) is obtained based on the square of the error signal e according to Formula (4), and thus, compared to Formula (2), the convolution between the reference signal r and the error signal e is not necessary, which makes it possible to reduce the amount of calculation.

With this, the active vibration noise reduction device 100 further improves the convergence speed and ensures the control stability and the control performance.

The step size parameter μW(t) may be obtained, in Formula (1), by dividing the value ρW(t), obtained according to Formula (2) based on the error signal e, by value based on the reference signal r.

With this configuration, the step size parameter μW(t) is large when the reference signal r is small and thus the convergence speed is maintained. On the other hand, the step size parameter μW(t) is small when the reference signal r is large, preventing the divergence due to the update amount ΔW being too large.

The step size parameter μW(t) may be obtained, in Formula (1), based on a value calculated by dividing a value obtained by adding a predetermined second positive number β to a value obtained based on the error signal e according to Formula (2) by a value obtained by adding a predetermined first positive number σ to a value obtained based on the reference signal r.

With this configuration, it is possible to prevent the step size parameter μW(t) from being too large and diverging when the reference signal r is small in Formula (1). Furthermore, it is possible to prevent the step size parameter μW(t) from being too small when the reference signal r is large so that the learning stops.

In Formula (1), the predetermined first positive number σ is set to a small positive number so that the denominator does not become too small, in order to avoid the update amount ΔW from becoming too large to cause the divergence of control. For example, without considering the influence of the numerator, when the maximum value of the step size parameter μW(t) is desired not to be 10 times or more the fixed value μ0 (see Formula (2)), the predetermined first positive number σ is set to 0.1 or more, for example.

In addition, in Formula (1), the predetermined second positive number β is set to a small positive number so that the numerator does not become too small, in order to avoid the learning from stopping due to a small update amount ΔW. For example, without considering the influence of the denominator, when the minimum value of the step size parameter μW(t) is desired not to be equal to or less than 0.1 times the set fixed value μ0, the predetermined second positive number β is set to 0.1 or more, for example.

As described above, the range of the step size parameter μW(t) is limited by setting the predetermined first positive number α and the predetermined second positive number β.

The active vibration noise reduction device 100 may further include the primary path filter Ĥ that presents an estimation value of the transfer function of the primary path from the noise source d to the microphone 30. The primary path filter Ĥ may be adaptively updated according to an update amount obtained by multiplying a virtual error signal el calculated based on the error signal e and the cancellation sound y, a step size parameter μHC(t) calculated based on the virtual error signal el, and the reference signal r.

With this configuration, the active vibration noise reduction device 100 automatically calculates the step size parameter μHC(t) according to the magnitude of the virtual error signal el and thus is able to update the adaptive filter coefficient with an optimal value and easily set the filter coefficient in the primary path filter Ĥ.

Here, the virtual error signal el is generated by the virtual error signal generator 47 as described above. Specifically, the virtual error signal generator 47 generates the virtual error signal el by adding the error signal e input from the microphone 30, the cancellation sound estimation signal ŷ with inverted polarity input from the cancellation sound estimation signal inverter 45, and the noise estimation signal \hat{d} with inverted polarity input from the noise estimation signal inverter 46.

The step size parameter μHC(t) for updating the primary path filter Ĥ will be described later together with the update of the secondary path filter Ĉ using Formulas (5) and (6).

The secondary path filter Ĉ may be adaptively updated according to an update amount obtained by multiplying the virtual error signal el calculated based on the error signal e and the cancellation sound y, a step size parameter μHC(t) calculated based on the virtual error signal el, and a convolution between the reference signal r and the control filter W.

With this configuration, the active vibration noise reduction device 100 updates the adaptive filter coefficients with optimal values and easily sets the filter coefficients to the secondary path filter Ĉ because the step size parameter μHC(t) is automatically calculated according to the magnitude of the virtual error signal el.

Here, a description will be given of the primary path filter Ĥ and the step size parameter μHC(t) used to update the secondary path filter Ĉ will now be described. The step size parameter μHC(t) is calculated according to the following Formulas (5) and (6).

$${μ}_{HC} ( t ) = {μ}_{0} \frac{\vert {ρ}_{HC} ( t ) \vert + β}{‖ r ( t ) ‖ + ‖ r ( t ) * W ( t ) ‖ + σ} \qquad ( 5 )$$

$${ρ}_{HC} ( t ) = λ {ρ}_{HC} ( t ) + ( 1 - λ ) ( r ( t ) * e 1 ( t ) ) \qquad ( 6 )$$

where
μ0: Preset fixed value of step size parameter
σ, β: Small positive number
*: Convolution operation
∥⋅∥: Norm of signal vector
λ: Oblivion coefficient (0<λ<1)

With this, the primary path updater 44 adaptively updates the primary path filter Ĥ of the noise estimation signal generator 43 according to the update formula of Formula (7).

$$\hat{H} ( t + 1 ) = \hat{H} ( t ) + {μ}_{HC} ( t ) e 1 ( t ) r ( t ) \qquad ( 7 )$$

In addition, the secondary path updater 42 adaptively updates the secondary path filter Ĉ of the cancellation sound estimation signal generator 41 according to the following update formula (8), and at the same time, updates the secondary path filter Ĉ of the secondary path filter part 12 to be the same as the secondary path filter Ĉ of the cancellation sound estimation signal generator 41

$$\hat{C} ( t + 1 ) = \hat{C} ( t ) + {μ}_{HC} ( t ) e 1 ( t ) ( r ( t ) * W ( t ) ) \qquad ( 8 )$$

In this way, the primary path updater 44 adaptively updates the primary path filter Ĥ of the noise estimation signal generator 43; and the secondary path updater 42 adaptively updates the secondary path filter Ĉ of the cancellation sound estimation signal generator 41 and the secondary path filter Ĉ of the secondary path filter part 12.

With this, the active vibration noise reduction device 100 automatically adjusts the update amounts as illustrated in Formulas (7) and (8). That is, the active vibration noise reduction device 100 improves the convergence speed because the update amount is large when the virtual error signal el is large as in the initial stage of control, for example. On the other hand, the active vibration noise reduction device 100 improves the accuracy of the adaptive update because, for example, when the virtual error signal el is small as in the case after the control has converged, the update amount is also small.

1. An active vibration noise reduction device comprising:
a speaker for outputting a cancellation sound for canceling a noise;
a microphone for generating an error signal from the noise and the cancellation sound;
a control filter configured to generate a control signal for controlling the cancellation sound from a reference signal; and
a secondary path filter configured to present an estimation value of a transfer function from the speaker to the microphone,
wherein the control filter is further configured to be adaptively updated with an update amount obtained by multiplying the error signal, a step size parameter calculated based on the error signal, and a result of convolution between the reference signal and the secondary path filter.

2. The active vibration noise reduction device according to claim 1,
wherein the step size parameter is obtained based on a convolution between the error signal and the reference signal.

3. The active vibration noise reduction device according to claim 1,
wherein the step size parameter is obtained based on a square of the error signal.

4. The active vibration noise reduction device according to claim 1,
wherein the step size parameter is obtained based on a value calculated by dividing a value obtained based on the error signal by a value obtained based on the reference signal.

5. The active vibration noise reduction device according to claim 1,
wherein the step size parameter is obtained based on a value calculated by dividing a value obtained by adding a predetermined first positive number to a value obtained based on the error signal by a value obtained by adding a predetermined second positive number to a value obtained based on the reference signal.

6. The active vibration noise reduction device according to claim 1, further comprising:
a primary path filter configured to present an estimation value of a transfer function of a primary path from a noise source to the microphone,
wherein the primary path filter is configured to be adaptively updated according to an update amount obtained by multiplying: a virtual error signal calculated based on the error signal and the cancellation sound, a step size parameter calculated based on the virtual error signal, and the reference signal.

7. The active vibration noise reduction device according to claim 1,
wherein the secondary path filter is configured to be adaptively updated according to an update amount obtained by multiplying: a virtual error signal calculated based on the error signal and the cancellation sound, a step size parameter calculated based on the virtual error signal, and a convolution between the reference signal and the control filter.
